(19) United States
(12) Patent Application Publication
(10) Pub. No.: US 2024/0273051 A1
(43) Pub. Date: Aug. 15, 2024

(54) TUNNELING OVER UNIVERSAL SERIAL BUS (USB)

(71) Applicant: QUALCOMM Incorporated, San Diego, CA (US)

(72) Inventors: Ziv LANDESBERG, Haifa (IL); Gil ZUKER, Haifa (IL); Tom YAHALOM, Maagan Michael (IL); Ziv HOROVITZ, San Diego, CA (US); Adi MENACHEM, Hod Hasharon (IL); Tomer Rafael BEN-CHEN, Amikam (IL); Amit GIL, Zichron Yaakov (IL)

(21) Appl. No.: 18/169,764

(22) Filed: Feb. 15, 2023

(51) Int. Cl. G06F 13/42; G06F 13/38

(52) U.S. Cl. CPC G06F 13/4282; G06F 13/382; G06F 2213/0042

(57) ABSTRACT

Some aspects of the disclosure provide various techniques for tunneling a Universal Serial Bus (USB) packet using cut-through techniques in a USB4 system. The disclosed cut-through techniques can avoid the use of store-and-forward (SAF) operations to tunnel a USB3 packet (e.g., USB 3.2 packet) through a USB4 link so that the latency of the tunneled USB3 packet can be reduced. Furthermore, the disclosed cut-through techniques can reduce the need for a large data buffer in a USB controller/adapter when SAF operations are used to tunnel USB3 packets.

### TECHNICAL FIELD

The technology discussed below relates generally to data communication buses, and more particularly, to tunneling data using communication buses such as the Universal Serial Bus (USB).

### INTRODUCTION

Computing devices can employ various communication protocols and standards to communicate with one another for different applications and functions. Some examples of computing devices include desktop computers, servers, notebook computers, network entities (e.g., aggregated or disaggregated base stations), and mobile devices (e.g., smartphones, smartwatches, and tablets, etc.). Among others, the Universal Serial Bus (USB) is an industry standard that establishes specifications for cables, connectors, and protocols for connection, communication between computing devices, peripherals, and other devices.

USB 4.0 (also known as USB4) is the newest generation of the USB standard. USB4 functionally replaces earlier USB 3.2 while retaining USB 2.0 bus operating in parallel. Enhanced SuperSpeed (SS) USB, as defined in the USB 3.2 Specification, remains as the architecture for USB data transfer on a USB4 connection. In some aspects, a USB4 connection can support multiple high-speed interface protocols, including USB3, DisplayPort, and PCI Express for efficient data transfer and simultaneous delivery of data, power, and high-resolution video through a single USB Type-C cable. USB4 has a tunneling architecture designed to combine multiple protocols onto a single physical interface (e.g., USB Type-C), so that the total speed and performance of the USB4 connection can be dynamically shared between protocols. In some aspects, a USB4 connection can tunnel USB 3.2 communication (USB3).

USB4 introduces the ability to dynamically control bandwidth allocation between various protocols, as well as doubling the maximum available bandwidth. USB4 fabric is a data transmission protocol based on Intel's Thunderbolt 3 standard (Thunderbolt™ is a registered trademark of Intel Corporation). Thunderbolt 3 protocol is USB4′s primary method of moving data across its connection, and a USB4 connection can be used as a tunnel for USB3, DisplayPort, and PCIe (Peripheral Component Interconnect Express) signals through the same physical cable.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Various method, system, device, and apparatus embodiments may also include additional features. Some aspects of the disclosure provide various techniques for tunneling a Universal Serial Bus (USB) packet using cut-through techniques in a USB4 system. The disclosed cut-through techniques can avoid the use of store-and-forward (SAF) operations to tunnel a USB3 packet (e.g., USB 3.2 packet) through a USB4 link so that the latency of the tunneled USB3 packet can be reduced. Furthermore, the disclosed cut-through techniques can reduce the need for a large data buffer in a USB controller/adapter when SAF operations are used to tunnel USB3 packets.

One aspect of the disclosure provides an apparatus for data communication. The apparatus includes a memory and a universal serial bus (USB) component. The USB component is configured to receive a plurality of first data packets in sequence from a USB link, and the plurality of first data packets are in compliance with a first communication protocol and configured to tunnel a second data packet in compliance with a second communication protocol that is different from the first communication protocol. The USB component is further configured to decapsulate a subset of the plurality of first data packets to retrieve a partial payload of the second data packet. The USB host is further configured to store the partial payload of the second data packet decapsulated from the subset of the plurality of first data packets in the memory prior to receiving all of the plurality of first data packets.

One aspect of the disclosure provides a method for data communication at an apparatus. The method includes receiving a plurality of first data packets in sequence from a universal serial bus (USB) link. The plurality of first data packets are in compliance with a first communication protocol and configured to tunnel a second data packet in compliance with a second communication protocol that is different from the first communication protocol. The method further includes decapsulating a subset of the plurality of first data packets to retrieve a partial payload of the second data packet. The method further includes storing the partial payload of the second data packet decapsulated from the subset of the plurality first data packets in a memory prior to receiving all of the plurality of first data packets.

One aspect of the disclosure provides an apparatus for data communication. The apparatus includes a memory and a universal serial bus (USB) component coupled to the memory. The USB host is configured to fetch data from the memory to construct a first data packet in compliance with a first communication protocol. The USB host is further configured to form one or more second data packets in compliance with a second communication protocol that is different from the first communication protocol. Each of the one or more second data packets includes a payload for tunneling a portion of the first data packet. The USB host is further configured to send the one or more second data packets using a USB link, prior to completing the construction of the first data packet.

These and other aspects of the present disclosure will become more fully understood upon a review of the detailed description, which follows. Other aspects, features, and implementations will become apparent to those of ordinary skill in the art, upon reviewing the following description of specific, exemplary implementations in conjunction with the accompanying figures. While features may be discussed relative to certain examples and figures below, all implementations can include one or more of the advantageous features discussed herein. In other words, while one or more implementations may be discussed as having certain advantageous features, one or more of such features may also be used in accordance with the various examples discussed herein. In a similar fashion, while examples may be discussed below as device, system, or method implementations, it should be understood that such examples can be implemented in various devices, systems, and methods.

### BRIEF DESCRIPTION OF THE DRAWINGS

FIG. 1 is a schematic diagram illustrating an exemplary universal serial bus (USB) system according to some aspects of the disclosure.

FIGS. 2, 3, and 4 are schematic diagrams illustrating more detail of exemplary USB devices, according to some aspects of the disclosure.

FIG. 5 is a schematic diagram illustrating an exemplary USB protocol stack according to some aspects of the disclosure.

FIG. 6 is a diagram conceptually illustrating a USB3 packet tunneled using multiple USB4 packets according to some aspects of the disclosure.

FIG. 7 is a block diagram of a USB device configured to implement various cut-through techniques to tunnel a USB3 packet using USB4 packets according to some aspects of the disclosure.

FIG. 8 is a diagram illustrating a process of receiving a tunneled USB3 packet using cut-through techniques according to some aspects of the disclosure.

FIG. 9 is a diagram conceptually illustrating a memory space of the USB device of FIG. 7 according to some aspects of the disclosure.

FIG. 10 is a diagram illustrating a process of sending a tunneled USB3 packet using cut-through techniques according to some aspects of the disclosure.

FIG. 11 is a flow chart illustrating an exemplary method for receiving tunneling data packets according to some aspects of the disclosure.

FIG. 12 flow chart illustrating an exemplary method for sending tunneling data packets in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chips and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and UE), end-user devices, etc. of varying sizes, shapes and constitution.

Some aspects of the disclosure provide various techniques for tunneling a Universal Serial Bus (USB) packet using cut-through techniques in a USB4 system. The disclosed cut-through techniques can avoid the use of store-and-forward (SAF) operations to tunnel a USB3 packet (e.g., USB 3.2 packet) through a USB4 link so that the latency of the tunneled USB3 packet can be reduced. Furthermore, the disclosed cut-through techniques can reduce the need for a large data buffer in a USB controller/adapter when store-and-forward (SAF) operations are used to tunnel USB3 packets.

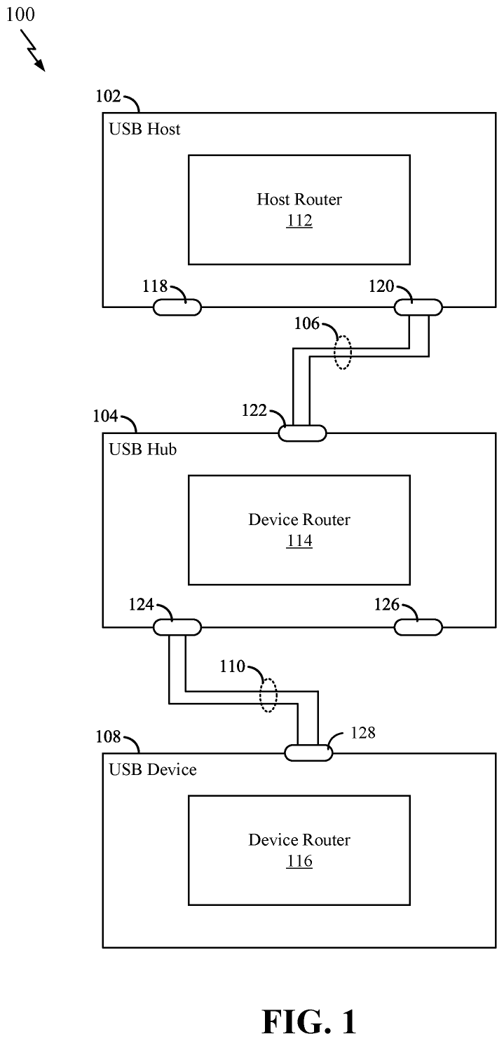

FIG. 1 is a schematic diagram of an exemplary universal serial bus (USB) system 100 according to some aspects of the present disclosure. In some aspects, the USB system 100 has a bus architecture that uses the USB4 communication protocol. In some aspects, the USB system 100 is a USB4 system that is backward compatible with older USB generations (e.g., USB 2.0 to USB 3.2).

The USB system 100 can include a USB host 102 connected to a USB hub 104 by a USB link 106. In some aspects, the USB host 102 can be a USB4 host that can be included in or connected to a processing device or subsystem (e.g., a computer, a server, a motherboard, a controller, a mobile phone, etc.). In some aspects, the USB hub 104 can be a USB4 hub that connects to one or more USB devices (e.g., a USB device 108 shown in FIG. 1) by a USB link 110. The USB hub 104 can also be connected to other types of devices, such as displays or other peripheral devices. The USB hub 104 can be a standalone device or included in another device (e.g., a USB docking station). The USB device 108 can include one or more USB endpoints or functionalities. In some aspects, the USB device 108 can be a peripheral device, a memory, or any device that connects to the USB host 102 directly or via the USB4 hub 104. In some aspects, the USB host 102 can be a USB4 host that can support 20 or higher Gbps (gigabits per second) USB4 operation (e.g., Gen 2×2, Gen 3×2).

In some aspects, the USB host 102 can include a USB host router 112, the USB hub 104 can include a USB hub router 114, and the USB device 108 can include a USB device router 116. In a USB4 system, a router can translate tunneled protocol traffic (e.g., USB3 packets) to USB4 packets and route packets through the USB4 system 100 (e.g., USB4 fabric including links 106 and 110). Tunneled protocol traffic is tunneled through a USB4 fabric as USB4 packets. One example of tunneled protocol traffic is USB3 traffic (e.g., USB 3.2 traffic). In some aspects, each of the USB host 102, USB hub 104, and USB device 108 can include one or more USB connector ports 118, 120, 122, 124, 126, and 128, respectively. In one example, the USB connector ports can be implemented using USB Type-C connectors for connecting USB-compliant components and for transferring information and power between components.

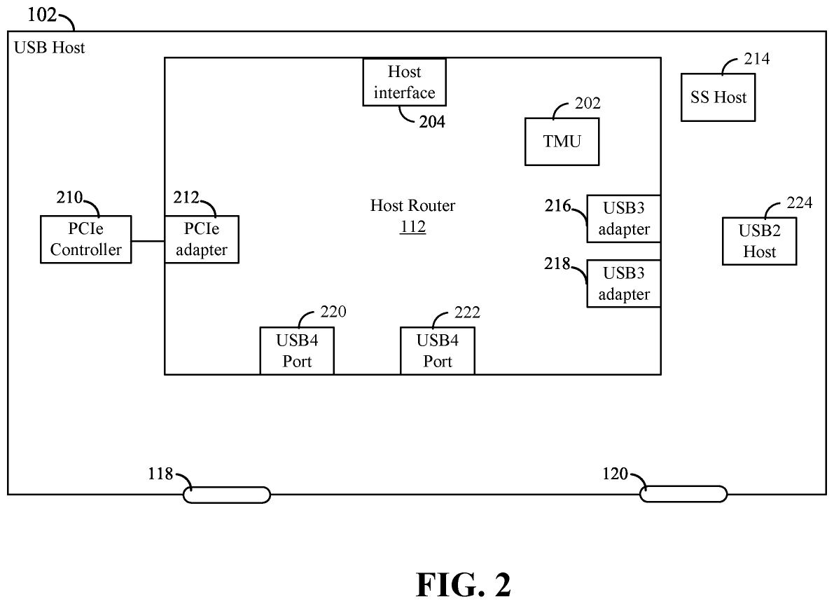

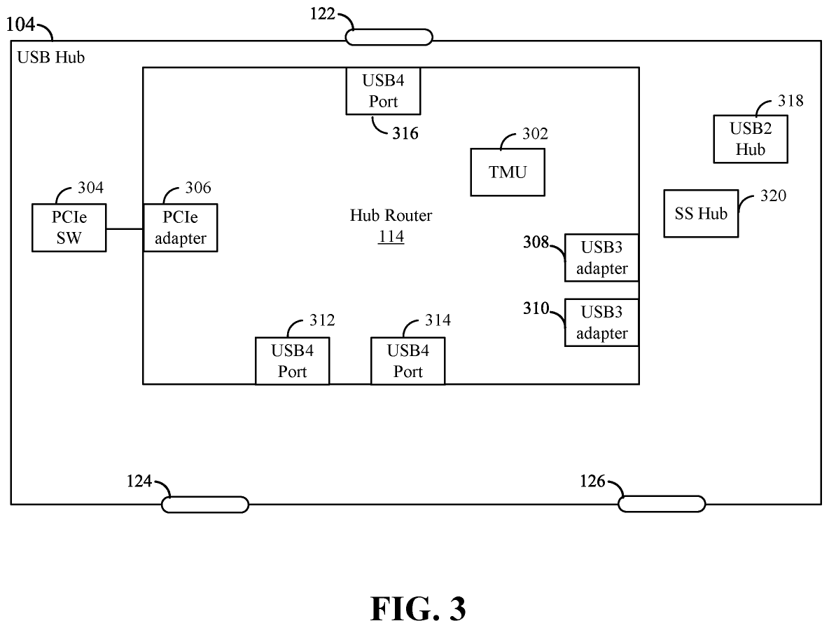

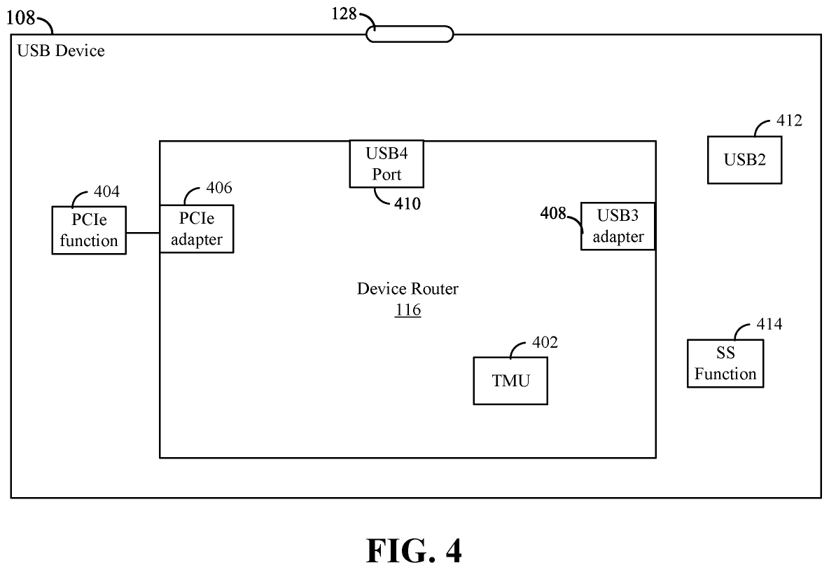

FIGS. 2, 3, and 4 are schematic diagrams illustrating more detail of the USB host 102, USB hub 104, and USB device 108, respectively, according to some aspects of the disclosure. Each of the USB host 102, USB hub 104, and USB device 108 has a router (e.g., routers 112, 114, and 116) for routing USB traffic. The routers can distribute and synchronize time throughout the USB system 100 via a time management Unit (TMU). For example, the USB host 102 has a TMU 202 (FIG. 2), the USB hub 104 has a TMU 302 (FIG. 3), and the USB device 108 has a TMU 402 (FIG. 4). The USB host 102 has a host interface adapter 204 that can perform functions related to discovery and configuration of the routers. Each router provides a flat point-to-point, configurable switch for routing traffic between various adapters or ports (e.g., between USB3 and USB4 ports or adapters).

In some aspects, the USB host 102 may include a PCIe (Peripheral Component Interconnect Express) controller 210 (FIG. 2). The PCIe controller 210 can include (or be connected to) a PCIe root complex or PCIe switch complex for controlling PCIe-based routing to one or more peripheral devices. The PCIe controller 210 can be connected to the USB host router 112 through a PCIe adapter 212. In some aspects, the USB hub 104 includes (or is connected to) a PCIe switch 304 via a PCIe adapter 306 (e.g., a PCIe downstream or upstream facing adapter). In some aspects, the USB device 108 can include a PCIe function 404 that is the PCIe downstream connected component (endpoint device) that communicates with the PCIe controller 210 (see USB host 102 of FIG. 2) across a USB4 connection (e.g., USB links 106 and 110). The USB device router 116 can include a PCIe upstream adapter 406 to couple the PCIe function 404 with upstream connected components, such as the PCIe switch 304 of the USB hub 104 and the PCIe controller 210 of the USB host 102.

In some aspects, the USB host 102 includes an internal enhanced SuperSpeed (SS) host 214 that can provide one or more downstream USB3 ports, which can be connected to a downstream USB3 protocol adapter (e.g., USB3 adapters 308 and 310). The USB hub 104 includes an internal enhanced SuperSpeed hub (e.g., SS hub 320), that provides one or more upstream USB3 ports and downstream USB3 ports. The upstream USB3 port can be connected to an upstream USB3 protocol adapter (e.g., USB3 adapter 308) that forwards packets to the upstream facing port of the USB4 hub. The downstream USB3 port can be connected to a downstream USB3 protocol adapter (e.g., USB3 adapter 310) that forwards packets to the downstream facing port of the USB4 hub.

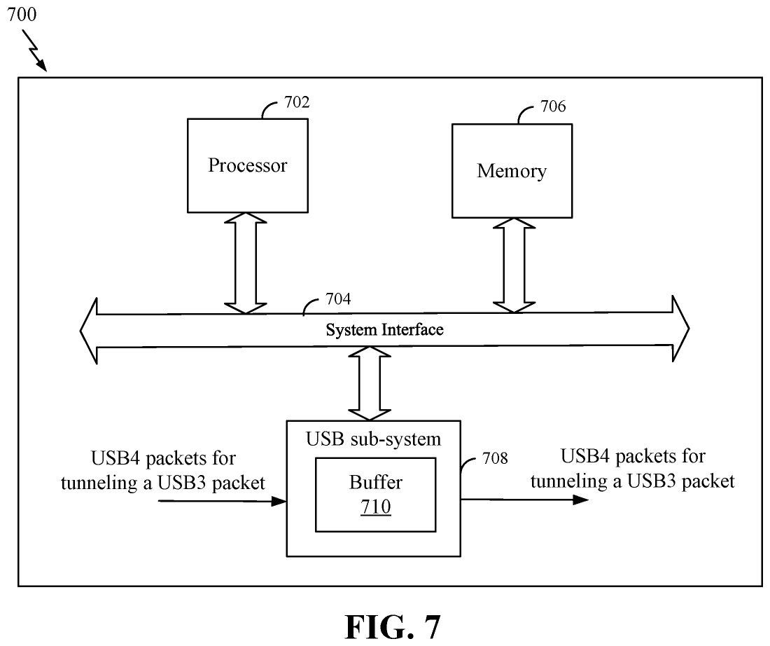

Each router (e.g., routers 112, 114, and 116) can include one or more adapters (e.g., PCIe adapter, DisplayPort (DP) adapter, USB3 adapter, etc.). An adapter can provide an interface between a router (e.g., routers 112, 114, and 116) and an external entity or functionality. The USB system 100 can support three types of adapters: protocol adapters, lane adapters, and control adapters. A protocol adapter is used to translate communication or traffic between different protocols for supporting tunneling. In some aspects, a router may include one or more types of protocol adapters. In one example, the USB host 102 includes two USB3 adapters 216 and 218, a host interface 204, and a PCIe adapter 212. In one example the USB hub 104 includes two USB3 adapters 308 and 310 and a PCIe adapter 306. In one example, the USB device 108 includes a USB3 adapter 408 and a PCIe adapter 406. In some aspects, the host interface 204 can provide an interface for a processing device (e.g., processor 702 of FIG. 7) to access the USB host 102 or host router 112.

In some aspects, each router of the USB host 102, USB hub 104, and USB device 108 can include one or more USB4 ports. A USB4 port (an entity in the router) provides a USB4 functional interface that resides on each end of a USB4 link or connection (e.g., USB links 106 and 110). A USB4 link includes a USB4 data bus along with a two-wire sideband (SB) channel. The USB4 data bus includes transmit and receive lanes. A USB4 link operates as either a single-lane link or dual-lane link (e.g., lane 0 and lane 1). When operating as a single-lane link, one lane (e.g., lane 1) of the USB4 port is disabled. When operating as a dual-lane link, both lanes (e.g., lanes 0 and 1) are enabled and logically bonded together to provide a single data channel. In one example, the host router 112 can include two USB4 ports 220 and 222 (FIG. 2). In one example, the device router 116 can include a USB4 port 410. In some aspects, the hub router 114 can include one or more downstream facing USB4 ports (e.g., USB4 ports 312 and 314) and an upstream facing USB4 port (e.g., USB4 port 316). The hub router 114 enables one or more downstream facing USB4 ports to be served by one upstream facing USB4 port (e.g., for port expansion).

In the USB system 100, the USB4 link can be the primary communication channel that interconnects two USB4 ports. In some aspects, the USB4 link can transport data packets for both tunneled protocol traffic and bus management traffic between routers. The sideband channel of a USB4 port can be used to initialize and manage the USB4 link between the connected USB4 ports. In one example, a USB4-enabled USB Type-C port includes a USB4 port, a USB 2.0 data bus, and a USB Type-C configuration channel (CC) along with power and ground.

In some aspects, the USB hub 104 (e.g., router 114) can support earlier USB generation or functionality. For example, the downstream facing ports (e.g., USB4 ports 312 and 314) of the USB hub 104 can be backward-compatible with USB 3.2 and USB 2.0 devices. In one example, the USB host 102 can include USB 2.0 functionality provided via a USB 2.0 host 224 that can be connected to a USB 2.0 hub 318 (included in the USB hub 104) and/or a USB 2.0 function 412 (included in the USB device 108). In some aspects, the USB host 102, USB hub 104, and USB device 108 can support 20 G (20 Gbit/s) USB4 operation (Gen2×2) or 40 G (40 Gbit/s) USB4 operation (Gen3×2). However, it is contemplated that the USB system 100 can achieve higher throughput than 40 G (e.g., 80 G in USB Gen 4) in other aspects.

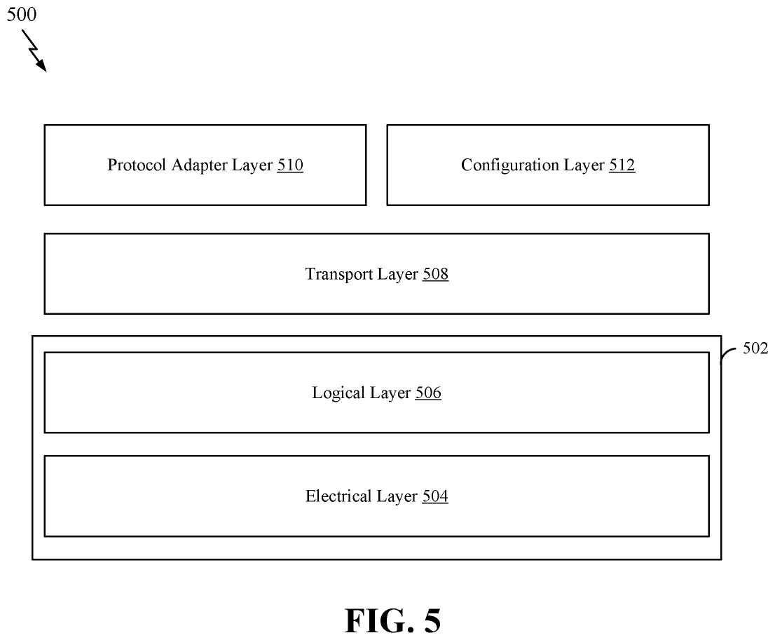

FIG. 5 is a schematic diagram of an exemplary USB protocol stack 500 according to some aspects of the disclosure. In one aspect, the USB protocol stack 500 can be a USB4 protocol stack that includes a physical layer 502 including an electrical layer 504 and a logical layer 506. The USB protocol stack 500 further includes a protocol adapter layer 510 and a configuration layer 512 above a transport layer 508.

The electrical layer 504 defines various electrical signaling characteristics of a USB link, for example, scrambling, encoding, jitter, and voltage. The logical layer 506 is responsible for establishing a USB4 link between two routers (e.g., routers 112, 114, and 116) and provides services to transmit and receive data traffic between the routers. The logical layer 506 further handles the traffic to and from the transport layer 508 as a byte stream. The logical layer 506 provides services for the establishment and maintenance of a USB4 link with a link partner (e.g., another USB-enabled device or peer). Other services provided by the logical layer 506 include, for example, performance scalability (e.g., different data communication speeds and widths), error detection and recovery mechanisms, data scrambling, forward-error-correcting codes, power management, etc.

In some aspects, the transport layer 508 forwards tunneled packets (e.g., USB3 packets, DP packets, PCIe packets) and control packets through a USB link (e.g., USB links 106 and 110). For example, the transport layer 508 can define packet format, routing, Quality-of-Service (QoS) support, flow control, and time synchronization. Protocol multiplexing (e.g., USB4 and USB3 traffic multiplexing) can further be performed at the transport layer 508. The configuration layer 512 performs router configuration tasks and handles incoming control packets. The configuration layer 512 provides an addressing scheme for control packets within the domain, processes control packets, and delivers a reliable transport mechanism for control packets. Control packets provide the connection manager with access to the configuration spaces of a router. The protocol adapter layer 510 performs mapping/translation between tunneled protocol traffic (e.g., USB3 traffic) and USB4 transport layer packets. The protocol adapter layer 510 is defined by the type of tunneled protocol traffic it sends and receives, for example, a USB3 adapter layer.

### USB4 Tunneling

In some aspects, the USB host 102, USB hub 104, and/or USB device 108 can support tunneling of various protocols, for example, USB3 tunneling, PCIe tunneling, etc. The above-described USB3 controller and adapters can support USB3 Gen T or Gen X tunneling. USB3 Gen T is a type of USB3 tunneling architecture. A USB3 Gen T path tunnels USB3 traffic between two USB3 Gen T adapters. USB Gen T port is a port on an internal USB3 Gen T component that supports USB3 Gen T operation. USB3 Gen X is a type of USB3 tunneling architecture that uses the existing USB 3.2 Enhanced SuperSpeed protocol. A USB3 Gen X path tunnels USB3 traffic between two USB3 Gen X Adapters. A USB3 Gen X port is a port on an internal USB3 component that supports USB3 Gen X operation. A USB3 path is a path that tunnels USB3 traffic. It can refer to both a USB3 Gen T path and a USB3 Gen X path.

In some aspects, a USB3 packet can be tunneled over a USB4 link between the USB host 102 and the USB device 108 with/without using the USB hub 104. The USB3adapter (e.g., USB3 adapter 216, 218, 308, 310, 408) within each router enables a USB3packet to be tunneled through the USB4 link (e.g., USB link 106 and/or USB link 110). For example, the USB3 packet can be transmitted and/or received between the enhanced SS host 214 (USB host 102 of FIG. 2) and enhanced SS function 414 (USB device 108 of FIG. 4) as native USB3 packets using USB3 tunneling. The SS host 214, SS hub 320, and SS function 414 can be referred to as internal USB3 devices in this disclosure. Each internal USB3 device interfaces to the USB3 adapter layer after the link layer. The USB3 adapter encapsulates a native USB3 protocol packet into one or more USB4 transport layer packets (tunneled packets). Each USB4 packet can carry a payload (e.g., a partial USB3 packet) of the tunneled USB3 packet.

In some aspects, the tunneling of USB3 traffic (e.g., a USB3 packet) over a USB4 link (as payloads in one or more USB4 packets) can operate on a USB3 protocol layer (e.g., USB 3.2 Gen T or Gen X adapter layer) that defines the tunneling and processing of USB3 traffic over a USB4 link. In some examples, store and forward techniques can be used to tunnel a USB3 packet as one or more USB4 packets that will be reassembled by the downstream USB3 adapter before the packet is forwarded to the destination (e.g., a processor 702 of FIG. 7 or a processing subsystem). The USB3 protocol layer can provide specific rules for bandwidth allocation and partitioning of periodic and non-periodic traffic types. In one example, periodic traffic can be limited to about 70 percent of link bandwidth (BW) for USB Gen T traffic. In one example, the periodic traffic can be limited to about 90 percent of link BW for USB Gen X traffic. In one example, each periodic endpoint (EP) can have its maximum BW defined in the corresponding endpoint descriptor and its companions. The endpoint descriptor and its companions can contain the properties of an endpoint. From these properties, the max BW of a periodic endpoint can be calculated.

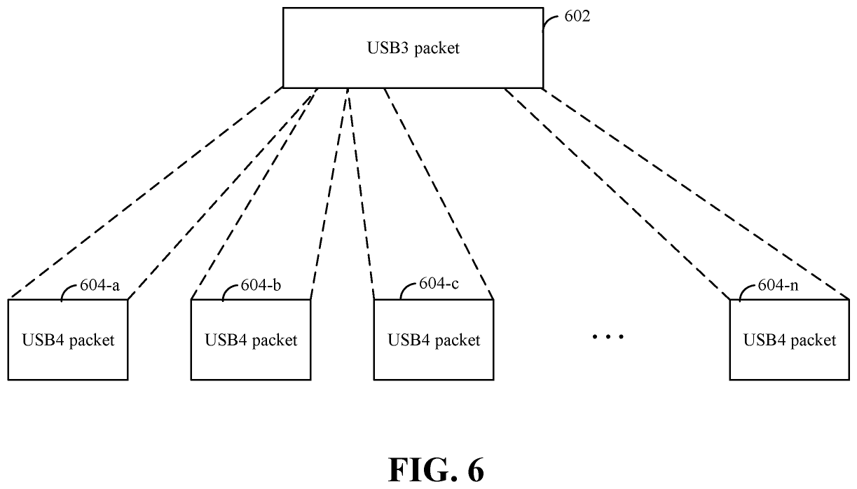

FIG. 6 is a diagram conceptually illustrating a USB3 packet 602 that can be tunneled using multiple USB4 packets (e.g., USB4 packets 604-a, 604-b, 604-c, . . . , 604-n shown in FIG. 6). In one example, the USB3 packet 600 may be 1024 bytes in size, and each USB4 packet can include a portion (e.g., a payload of 256 bytes or less) of the USB3 packet 602 as payload. The USB4 packets can be transmitted over a USB4 link, and are verified for correct reception at the receiver. In some aspects, USB3 tunneling (e.g., USB3 Gen X or Gen T tunneling) can be performed through a multi-port USB3 adapter port that is capable of tunneling traffic to/from several USB3 devices concurrently. In this case, for preventing blocking between the tunneled USB3 packets to/from different USB3devices, the USB3 adapter may need to provide a large data buffer in order to achieve a high overall throughput (e.g., 80 Gbps). However, using a larger buffer can result in added hardware cost and increased latency of the tunneled USB3 traffic when store-and-forward (SAF) operations are used.

Some aspects of the disclosure provide various techniques for tunneling a USB3 packet through a USB4 link using cut-through techniques. The disclosed cut-through techniques can avoid the use of store-and-forward (SAF) operations to tunnel a USB3 packet through a USB4 line so that the latency of the tunneled USB3 packet can be reduced. For example, when SAF is used, a USB3 controller and/or adapter needs to receive (and store) all USB4 packets that carry the payloads of a tunneled USB3 packet before the USB3 packet can be forwarded to the next destination (e.g., a processing device or another USB device). Furthermore, the cut-through operation can reduce the need for and the cost associated with a large data buffer for reducing blocking between USB3 packets of different devices as compared to the SAF operations.

FIG. 7 is a block diagram of a USB component 700 that can implement various cut-through techniques to tunnel a USB3 packet using USB4 packets according to some aspects. In some aspects, the UBS component 700 can be a USB host or a USB device. In one example, the USB component 700 includes a processor 702 that can be coupled to other devices via a system interface 704. In some aspects, the system interface 704 can be a data bus that is in compliance with the Advanced eXtensible Interface (AXI) bus. It is contemplated that the system interface 704 can be implemented using other bus architectures or parallel/serial interfaces (e.g., PCIe). The processor 702 is coupled to a memory 706 (e.g., memory 234 of FIG. 2) and a USB system 708. The USB system 708 enables the USB component 700 to communicate with other devices using a USB link (e.g., a USB4 link). The USB system 708 can be used to implement any of the USB components (e.g., USB host 102, USB hub 104, or USB device 108) as illustrated in FIGS. 1-4 or any suitable USB-enabled devices. The processor 702 can send and receive data to and from the memory 706 and the USB system 708 via the system interface 704. For example, each device (e.g., the processor 702 or USB system 708) can communicate with another device (e.g., memory 706) by exchanging address, control, and data information over the system interface 704. The USB system 708 can include a data buffer 710 that can be used to buffer and store USB packets received from the USB link.

In one aspect, the USB system 708 can provide USB3 functionality and USB4 functionality to enable the use of cut-through techniques described herein to tunnel a USB3 packet (e.g., USB 3.2 packet) using one or more USB4 packets. In one example, the USB system 708 can be implemented to include the functions of a USB3 host and a USB3 adapter (e.g., the SS host 214 and the USB3 adapter port 216/218). In one example, when a USB3 packet is tunneled using multiple USB4 packets, the USB system 708 can receive the USB4 packets in sequence. Using cut-through techniques, the USB system 708 can retrieve and store the payload (a partial USB3 packet) of each received USB4 packet in the memory 706 before all of the USB4 packets for tunneling the USB3 packet are received or processed. It is different from an SAF operation in which the USB system 708 would store the USB4 packets in the buffer 710 and reconstruct the complete USB3 packet after receiving all tunneling USB4 packets. Using the SAF method, the USB system 708 can forward the complete USB3 packet to the memory 706/processor 702.

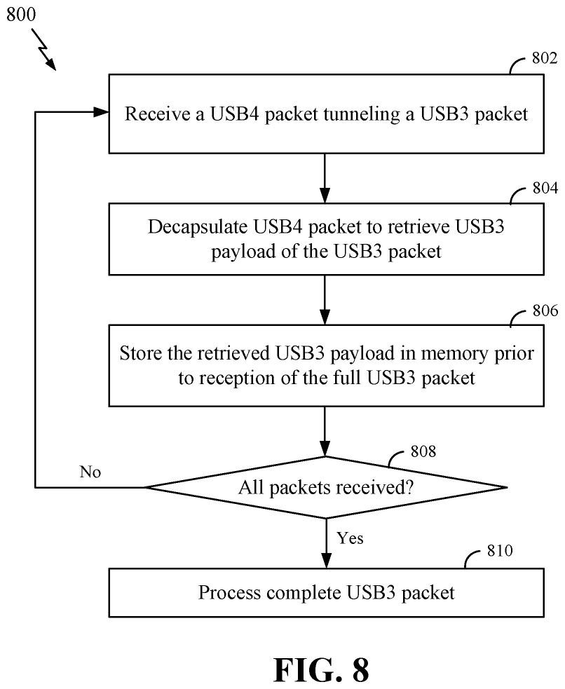

FIG. 8 is a diagram illustrating a process 800 of receiving a tunneled USB3 packet using cut-through techniques according to some aspects of the disclosure. In one example, the process 800 can be performed using the USB component 700 or any USB-enabled devices (e.g., USB host 102, USB device 108, etc.).

At block 802, the USB component 700 can receive a USB4 packet from a USB link (e.g., USB link 106 and/or USB link 110). The USB4 packet may include a payload for tunneling a USB3 packet. When the tunneled USB3 packet has a packet size not greater than a payload threshold (e.g., 252 bytes or less) of the USB4 packet, the USB3 packet can be tunneled using a single USB4 packet. When the USB3 packet has a size greater than the payload threshold of the USB4 packet, the USB3 packet can be tunneled using two or more USB4 packets (e.g., USB4 packets 604-a, 604-b, 604-c . . . , and 604-n). In this case, each USB4 packet carries a payload corresponding to a portion of the USB3 packet.

At block 804, the USB component 700 can decapsulate or deconstruct the USB4packet to retrieve the USB3 packet payload. For example, the USB component can unpack the header of the USB4 packet and use that information to obtain the USB3 packet payload encapsulated in the USB4 packet.

At block 806, the USB component 700 can store the USB3 payload (e.g., a partial USB3 packet) in a memory (e.g., memory 706) that is accessible by a processor (e.g., processor 702) for storing decapsulated USB3 payload (e.g., a partial USB3 packet) before all the tunneling USB4 packets are received. For example, the USB component 700 can further process the USB3 payload at an upper layer (e.g., user application layer or software) above the USB protocol layer (e.g., protocol adapter layer 510 of FIG. 5). In some aspects, the USB system 708 stores the USB3 payload in the memory 706 as soon as the USB3 payload is retrieved from the received USB4 packet(s) without buffering the USB4 packet at the USB system. In some aspects, the USB system 708 may temporarily buffer or store some USB4 packets in the buffer 710 but release the USB4 packets from the buffer before the complete USB3 packet is received via tunneling.

In some aspects, the USB component 700 can maintain reception information of the USB3 payload. For example, the reception information can indicate a length of the USB3 packet, a location of the partial USB3 payload stored in the memory, a memory offset for locating the USB3 payload data in the memory, and/or a cyclic redundancy check (CRC) of the second data packet. In some aspects, the USB3 payload may not be stored in the memory by packet boundary. Therefore, the USB component 700 can maintain the memory offsets for locating the USB3 payloads in the memory. In some example, the memory offsets may be page offsets of memory pages that store USB3payloads.

In some aspects, the CRC can span over the entire USB3 packet. In the cut-through approach, when receiving USB4 packets, the CRC is calculated over the partial USB3 payloads contained in the USB4 packets, while the USB system 708 can maintain the intermediate state in between packets. When the last USB4 packet arrives, using the intermediate CRC state, the entire CRC can be verified for all of the USB3 payloads and the result is handled and reported as if it was calculated at once on the complete USB3 packet. Similarly, in the transmission direction, the CRC can be calculated as the USB4 packets are transmitted with an intermediate CRC state preserved between packets, and then appended in the end of the last tunneling USB4 packet of the USB3 packet.

In some aspects, USB system 708 can wait for one or more USB4 packets that tunnel the USB3 payload before storing the decapsulated USB3 payload in the memory 706 in order to align the bus width and the amount of data transmitted across the system interface 704. For example, the USB system 708 can decapsulate a certain number of tunneling USB4 packets such that an amount of decapsulated USB3 payloads transferred across the bus has a size that aligns with the bus width of the interface. In one example, when the bus width of the system interface 704 is X bytes, the USB system 708 can transmit USB 3 payload data via the system interface in multiple of X bytes (e.g., 2X, 3X, . . . nX, etc.) in order to align the bus width and each data transfer. Aligning the bus width with the USB 3 payload data transferred can improve the utilization efficiency of the system interface 704.

At block 808, the USB component 700 determines whether or not all USB4packets (for tunneling the USB3 packet) have been received. If not all expected USB4packets are received, the process returns to block 802 to receive more USB4 packet(s); otherwise, the process goes to block 810. At block 810, after the USB component 700 receives all expected USB4 packets, the USB component 700 (e.g., processor 702) can retrieve and process the complete USB3 packet payload stored in the memory 706. For example, the processor 702 can reconstruct the USB3 packet from the payload data stored in the memory 706 by the USB system. Using these cut-through techniques, the USB system 708 can reduce or avoid the buffering of the USB4 packets of the tunneled USB3packet in the buffer 710, instead, the partial USB3 packet payload can be forwarded to the memory 706 where the processor 702 can reconstruct the USB3 packet while the USB system continues to receive more USB4 packets. Using the cut-through techniques, the USB component can start processing (e.g., decapsulation) each received USB4 packet to retrieve the tunneled USB3 payload before all USB4 packets used for tunneling the USB3 packet are received. To the contrary, the SAF operation would buffer the USB4 packets until all USB4 packets for tunneling a USB 3 packet are received.

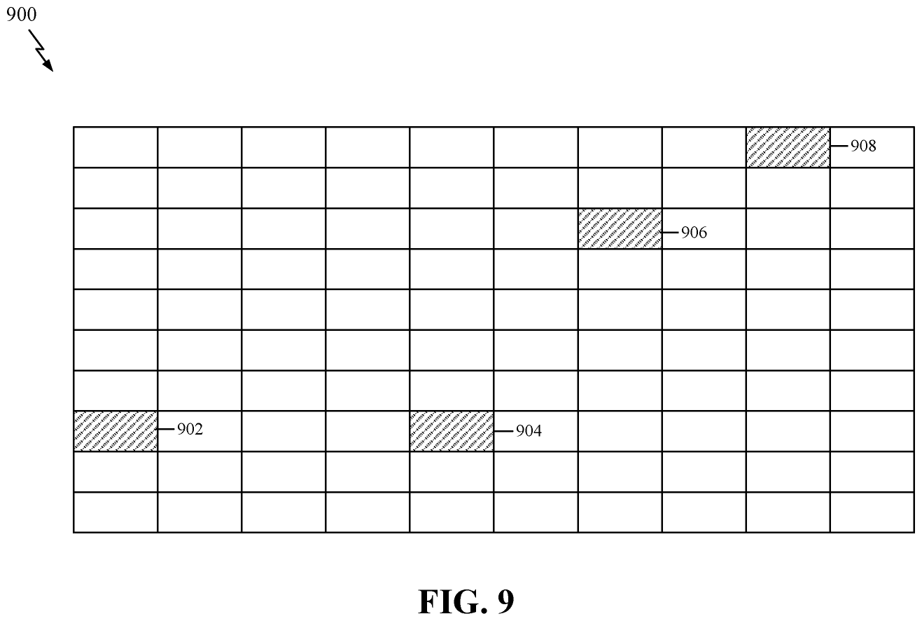

FIG. 9 is a diagram conceptually illustrating a memory space 900 of the USB component 700 according to some aspects. In one example, the memory space 900 can be in the memory 706 of FIG. 7 that is different from the buffer memory 710 used for buffering and routing USB4 packets at the USB system 708. In some aspects, the memory space 900 can be used by the processor 702 for functions other than USB communications, for example, user software or functions higher than the USB3 protocol layer.

In some aspects, the USB system 708 can receive the USB4 packets for tunneling a USB3 packet using the cut-through operation described above in relation to FIGS. 7 and 8. Without buffering the USB4 packets in the buffer, the USB system 708 can retrieve the USB3 payload from each received USB4 packet and store the partially received USB3 payloads in the memory space 900. In one example, the USB system 708 can store a first USB3 payload in a first memory location 902, a second USB3 payload in a second memory location 904, a third USB3 payload in a third memory location 906, and a fourth USB3 payload in a fourth memory location 908. The USB3 payload data can be stored in the memory locations using any partition, regardless of USB4 packet boundaries. For example, the payload of a single USB4 packet can be sent to several memory locations or the payloads of several USB4 packets can be sent to the same continuous memory location. The USB system 708 can store the USB3 payloads in the memory space 900 without first buffering some or all the corresponding USB4 packets at the buffer 710. In one example, the memory space 900 can be implemented in dynamic random access memory (DRAM) or the like.

The USB component can strategically store the USB3 payloads (e.g., a partial USB3 packet) in the memory space 900 to facilitate faster access. For example, the USB component 700 can store the USB3 payloads in the memory space 900 using techniques that enable the USB component 700 to retrieve the USB3 payload from the memory 900 using fewer memory access cycles (e.g., read accesses). In one example, the USB3payloads can be stored in memory locations corresponding to the same row of a memory read access. In another example, the USB3 payloads can be stored in the memory space 900 using a scatter and gather technique that facilitates the use of fewer memory read cycles to read the USB3 payload data from the memory.

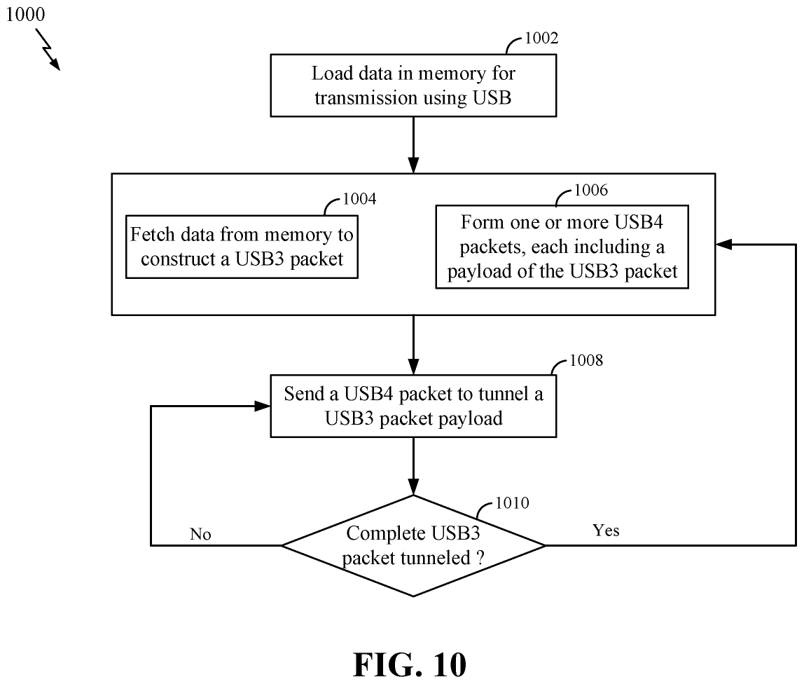

FIG. 10 illustrates a process 1000 of sending a tunneled USB3 packet using cut-through techniques according to some aspects of the disclosure. In one example, the process 1000 can be performed using the USB component 700 or any USB-enabled devices (e.g., USB host 102, USB device 108, etc.).

At block 1002, the USB component may have data to send using a USB connection, for example, a USB4 link to another device. For example, processor 702 can load the data to be sent in the memory 706 that can be accessed by the USB component or any USB controller/adapter.

At block 1004, the USB component can fetch the data from the memory to construct one or more USB3 packets that can be tunneled as one or more USB4 packets via a USB4 link (e.g., USB link 106). The USB component 700 can encapsulate the USB3 payload (e.g., a partial USB3 packet) in a USB4 packet. At block 1006, the USB component can construct or form one or more USB4 packets to tunnel the USB3 packet as a payload of the USB4 packet. When the USB3 packet has a size greater than a payload size of the USB4 packet, the USB component can tunnel the USB3 packet using two or more USB4 packets. The process of fetching data (USB3 payload data) from the memory to construct the USB3 packet and the process of forming the USB4 packets for tunneling the USB3 packet can occur concurrently. For example, the USB component can start forming the USB4 packets while the USB component fetches data from the memory to construct the USB3 packet fragment by fragment.

At block 1008, the USB component can send a USB4 packet with a payload (e.g., a partial USB3 packet) to tunnel the USB3 packet. In some aspects, the USB component can send the USB4 packet before the complete USB3 packet is constructed and/or all USB4 packets for tunneling the USB packet are formed. When the USB3 packet has a size greater than the payload threshold of the USB4 packet, the USB3 packet can be tunneled using two or more USB4 packets (e.g., USB4 packets 604-a, 604-b, 604-c . . . , and 604-n). Using the cut-through techniques, the USB component can start sending the USB4 packets before all USB4 packets (used for tunneling the USB3 packet) are constructed and ready.

At decision block 1010, the USB component 700 (e.g., USB subsystem 708) can return (No path in FIG. 10) to block 1008 to send more USB4 packet(s) for the same USB3 packet when the complete USB3 packet has not been sent or tunneled. Otherwise (Yes path in FIG. 10), the USB component 700 can return to block 1004/1006 to prepare another USB3 packet to be tunneled as USB4 packets. Using these cut-through techniques, the USB component can avoid or reduce the need to buffer the USB4 packets of the tunneled USB3 packet in the buffer 710.

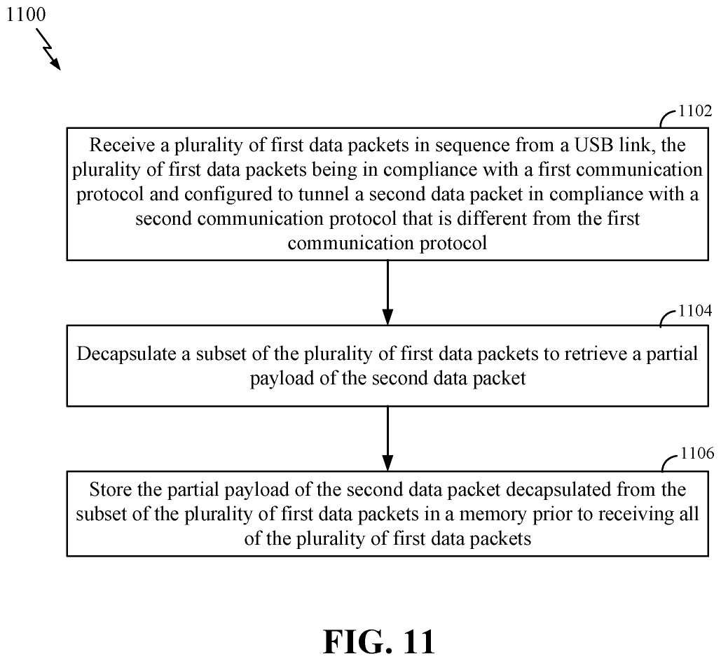

FIG. 11 is a flow chart illustrating an exemplary process/method 1100 for receiving tunneling data packets in accordance with some aspects of the present disclosure. As described below, some or all illustrated features may be omitted in a particular implementation within the scope of the present disclosure, and some illustrated features may not be required for implementation of all examples. In some examples, the process 1100 may be carried out by the USB component 700 illustrated in FIG. 7. In some examples, the process 1100 may be carried out by any suitable apparatus or means for carrying out the functions or algorithm described below.

At block 1102, the USB component can receive a plurality of first data packets in sequence from a USB link. The plurality of first data packets are in compliance with a first communication protocol and configured to tunnel a second data packet in compliance with a second communication protocol that is different from the first communication protocol. In one example, the first data packets may be USB4 data packets, and the second data packet may be a USB3 packet. In one example, the USB system 708 (FIG. 7) can provide a means (e.g., USB system 708) to receive the plurality of first data packets (e.g., USB4 packets for tunneling a USB3 packet) in sequence from a USB4 link (e.g., link 106).

At block 1104, the USB component can decapsulate a subset of the plurality of first data packets to retrieve a partial payload of the second data packet. In one aspect, the USB system 708 (FIG. 7) can provide a means to decapsulate the first data packets (e.g., one or more USB4 packets) to retrieve data corresponding to a partial USB3 packet. For example, the USB system 708 can decapsulate or deconstruct each received USB4 packet to retrieve the payload that contains a partial USB3 packet. For example, the USB component can unpack the header of the USB4 packet and use that information to obtain the USB3 packet payload encapsulated in the USB4 packet.

At block 1106, the USB component can store the partial payload of the second data packet decapsulated from the subset of the plurality of first data packets in the memory prior to receiving all of the plurality of first data packets. In one aspect, the USB system 708 (FIG. 7) can provide a means to store the partial payload of the second data packet (e.g., USB3 packet) in the memory (e.g., memory 706) prior to receiving all of the plurality of first data packets (e.g., all USB4 tunneling packets). That is different from SAF in which the USB3 payloads are buffered as USB4 packets in the buffer (e.g., buffer 710). In this disclosure, the USB3 payload of each USB4 packet is retrieved and stored without waiting for all USB4 packets.

In some aspects, wherein the first communication protocol comprises a USB4 compliance protocol, and the second communication protocol comprises a USB3 compliance protocol. In some aspects, the USB component can maintain reception information of the second data packet. For example, the reception information can indicate at least one of: a length of the second data packet; a location of the partial payload stored in the memory; a memory offset for locating the second data packet in the memory; or a cyclic redundancy check of the second data packet.

In some aspects, the USB component can store the partial payload of the second data packet in the memory (e.g., memory 706) before receiving the entire second data packet. In some aspects, the second data packet includes a USB3 packet, and the plurality of first data packets include a plurality of USB4 packets respectively including payloads for tunneling the USB3 packet without using a store and forward technique.

In some aspects, the USB component can further receive the plurality of USB4 packets using a USB4 port, and forward a partial payload of the USB3 packet before receiving all of the plurality of USB4 packets.

In some aspects, the USB component can further align a size of the partial payload of the second data packet with a bus width of the memory.

In some aspects, the USB component can further receive a plurality of third data packets in sequence from the USB link, the plurality of third data packets being in compliance of the first communication protocol and configured to tunnel a fourth data packet in compliance of the second communication protocol; and the USB component can further process the plurality of third data packets and the plurality of first data packets based on respective priorities of the plurality of third data packets and the plurality of first data packets.

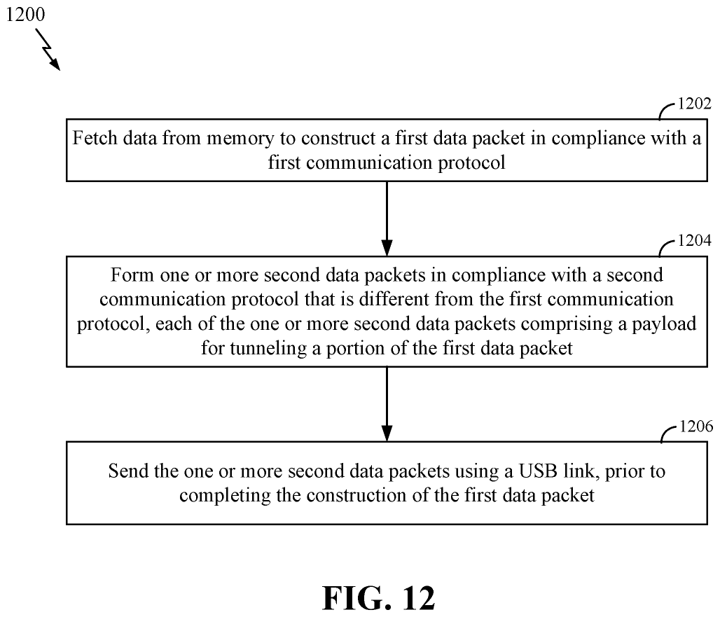

FIG. 12 is a flow chart illustrating an exemplary process/method 1200 for sending tunneling data packets in accordance with some aspects of the present disclosure. As described below, some or all illustrated features may be omitted in a particular implementation within the scope of the present disclosure, and some illustrated features may not be required for implementation of all examples. In some examples, the process 1200 may be carried out by the USB component 700 illustrated in FIG. 7. In some examples, the process 1200 may be carried out by any suitable apparatus or means for carrying out the functions or algorithm described below.

At block 1202, the USB component can fetch data from a memory to construct a first data packet in compliance with a first communication protocol. For example, the first data packet may be a USB3 packet in compliance with USB 3.2 specification. In one aspect, the processor 702 may store the data in the memory 706 for constructing the USB3 packet, and the USB system 708 can provide a means to fetch the data from the memory 706 to construct the first data packet.

At block 1204, the USB component can form one or more second data packets in compliance with a second communication protocol that is different from the first communication protocol. Each of the one or more second data packets includes a payload for tunneling a portion of the first data packet. For example, the second data packets may be USB4 packets in compliance with USB4 specification. In one aspect, the USB system 708 can provide a means to form the one or more second data packets (e.g., USB4 packets). For example, USB system 708 can encapsulate the first data packet (e.g., USB3 packet) in one or more second data packets. Each second data packet carries a payload corresponding to a portion (e.g., a partial USB3 packet) of the first data packet.

At block 1206, the USB component can send the one or more second data packets using a USB link, prior to completing the construction of the first data packet. In one aspect, the USB system 708 can provide a means to send the one or more second data packets (e.g., USB4 packets) to tunnel the USB3 packet.

In a first aspect, an apparatus for data communication is provided. The apparatus includes a memory and a universal serial bus (USB) component. The USB component is configured to: receive a plurality of first data packets in sequence from a USB link, the plurality of first data packets being in compliance with a first communication protocol and configured to tunnel a second data packet in compliance with a second communication protocol that is different from the first communication protocol; decapsulate a subset of the plurality of first data packets to retrieve a partial payload of the second data packet; and store the partial payload of the second data packet decapsulated from the subset of the plurality of first data packets in the memory prior to receiving all of the plurality of first data packets.

In a second aspect, alone or in combination with the first aspect, wherein the first communication protocol comprises a USB4 compliance protocol, and the second communication protocol comprises a USB3 compliance protocol.

In a third aspect, alone or in combination with the first aspect, wherein the USB component is configured to maintain reception information of the second data packet, the reception information indicates at least one of: a length of the second data packet; a location of the partial payload stored in the memory; a memory offset for locating the second data packet in the memory; or a cyclic redundancy check of the second data packet.

In a fourth aspect, alone or in combination with any of the first to third aspects, wherein the second data packet comprises a USB3 packet, and the plurality of first data packets comprise a plurality of USB4 packets respectively comprising payloads for tunneling the USB3 packet without using a store and forward technique.

In a fifth aspect, alone or in combination with the fourth aspect, wherein the USB component comprises: a USB4 port configured to receive the plurality of USB4 packets; and a USB controller configured to forward a partial payload of the USB3 packet before receiving all of the plurality of USB4 packets.

In a sixth aspect, alone or in combination with any of the first to third aspects, wherein the USB component is configured to: align a size of the partial payload of the second data packet with a bus width of the memory.

In a seventh aspect, alone or in combination with any of the first to third aspects, wherein the USB component is further configured to: receive a plurality of third data packets in sequence from the USB link, the plurality of third data packets being in compliance with the first communication protocol and configured to tunnel a fourth data packet in compliance with the second communication protocol; and process the plurality of third data packets and the plurality of first data packets in an order based on respective priorities of the plurality of third data packets and the plurality of first data packets.

In an eighth aspect, a method for data communication at an apparatus is provided. The method includes: receiving a plurality of first data packets in sequence from a universal serial bus (USB) link, the plurality of first data packets being in compliance with a first communication protocol and configured to tunnel a second data packet in compliance with a second communication protocol that is different from the first communication protocol; decapsulating a subset of the plurality of first data packets to retrieve a partial payload of the second data packet; and storing the partial payload of the second data packet decapsulated from the subset of the plurality first data packets in a memory prior to receiving all of the plurality of first data packets.

In a ninth aspect, alone or in combination with the eighth aspect, wherein the first communication protocol comprises a USB4 compliance protocol, and the second communication protocol comprises a USB3 compliance protocol.

In a tenth aspect, alone or in combination with the eighth aspect, the method further comprises: maintaining reception information of the second data packet, the reception information indicates at least one of: a length of the second data packet; a location of the partial payload stored in the memory; a memory offset for locating the second data packet in the memory; or cyclic redundancy check of the second data packet.

In an eleventh aspect, alone or in combination with any of the eighth to tenth aspects, wherein the second data packet comprises a USB3 packet, and the plurality of first data packets comprise a plurality of USB4 packets respectively comprising payloads for tunneling the USB3 packet without using a store and forward technique.

In a twelfth aspect, alone or in combination with the eleventh aspect, the method further comprises: forwarding a partial payload of the USB3 packet before receiving all of the plurality of USB4 packets.

In a thirteenth aspect, alone or in combination with any of the eighth to tenth aspects, the method further comprises: aligning a size of the partial payload of the second data packet with a bus width of the memory.

In a fourteenth aspect, alone or in combination with any of the eighth to tenth aspects, the method further comprises: receiving a plurality of third data packets in sequence from the USB link, the plurality of third data packets being in compliance with the first communication protocol and configured to tunnel a fourth data packet in compliance with the second communication protocol; and processing the plurality of third data packets and the plurality of first data packets based on respective priorities of the plurality of third data packets and the plurality of first data packets.

In a fifteenth aspect, an apparatus for data communication is provided. The apparatus includes a memory and a universal serial bus (USB) component coupled to the memory. The USB component is configured to: fetch data from the memory to construct a first data packet in compliance with a first communication protocol; form one or more second data packets in compliance with a second communication protocol that is different from the first communication protocol, each of the one or more second data packets comprising a payload for tunneling a portion of the first data packet; and send the one or more second data packets using a USB link, prior to completing the construction of the first data packet.

In a sixteenth aspect, alone or in combination with the fifteenth aspect, wherein the first communication protocol comprises a USB3 compliance protocol, and the second communication protocol comprises a USB4 compliance protocol.

In a seventeenth aspect, alone or in combination with the fifteenth aspect, wherein the USB component is further configured to: fetch an initial portion of the first data packet from the memory; and form the one or more second data packets using the initial portion of the first data packet.

In an eighteenth aspect, alone or in combination with the seventeenth aspect, wherein the USB component is further configured to: align a size of the initial portion of the first data packet fetched from the memory with a bus width of the memory.

In a nineteenth aspect, alone or in combination with any of the fifteenth to seventeenth aspects, wherein the first data packet comprises a USB3 packet, and the one or more second data packets comprise one or more USB4 packets respectively comprising payloads for tunneling the USB3 packet without using a store and forward technique.

In a twentieth aspect, alone or in combination with the nineteenth aspect, wherein the USB component is further configured to: send at least one of the one or more USB4 packets prior to completing the construction of the USB3 packet.

Several aspects of a data communication system have been presented with reference to an exemplary implementation. As those skilled in the art will readily appreciate, various aspects described throughout this disclosure may be extended to other data communication systems, network architectures and communication standards.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-12 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An apparatus for data communication, comprising:
a memory; and
a universal serial bus (USB) component, wherein the USB component is configured to:
receive a plurality of first data packets in sequence from a USB link, the plurality of first data packets being in compliance with a first communication protocol and configured to tunnel a second data packet in compliance with a second communication protocol that is different from the first communication protocol;
decapsulate a subset of the plurality of first data packets to retrieve a partial payload of the second data packet; and
store the partial payload of the second data packet decapsulated from the subset of the plurality of first data packets in the memory prior to receiving all of the plurality of first data packets.

2. The apparatus of claim 1, wherein the first communication protocol comprises a USB4 compliance protocol, and the second communication protocol comprises a USB3 compliance protocol.

3. The apparatus of claim 1, wherein the USB component is configured to maintain reception information of the second data packet, the reception information indicates at least one of:
a length of the second data packet;
a location of the partial payload stored in the memory;
a memory offset for locating the second data packet in the memory; or a cyclic redundancy check of the second data packet.

4. The apparatus of claim 1, wherein the second data packet comprises a USB3 packet, and the plurality of first data packets comprise a plurality of USB4 packets respectively comprising payloads for tunneling the USB3 packet without using a store and forward technique.

5. The apparatus of claim 4, wherein the USB component comprises:
a USB4 port configured to receive the plurality of USB4 packets; and
a USB controller configured to forward a partial payload of the USB3 packet before receiving all of the plurality of USB4 packets.

6. The apparatus of claim 1, wherein the USB component is configured to:
align a size of the partial payload of the second data packet with a bus width of the memory.

7. The apparatus of claim 1, wherein the USB component is further configured to:
receive a plurality of third data packets in sequence from the USB link, the plurality of third data packets being in compliance with the first communication protocol and configured to tunnel a fourth data packet in compliance with the second communication protocol; and
process the plurality of third data packets and the plurality of first data packets in an order based on respective priorities of the plurality of third data packets and the plurality of first data packets.

8. A method for data communication at an apparatus, comprising:
receiving a plurality of first data packets in sequence from a universal serial bus (USB) link, the plurality of first data packets being in compliance with a first communication protocol and configured to tunnel a second data packet in compliance with a second communication protocol that is different from the first communication protocol;
decapsulating a subset of the plurality of first data packets to retrieve a partial payload of the second data packet; and
storing the partial payload of the second data packet decapsulated from the subset of the plurality first data packets in a memory prior to receiving all of the plurality of first data packets.

9. The method of claim 8, wherein the first communication protocol comprises a USB4 compliance protocol, and the second communication protocol comprises a USB3 compliance protocol.

10. The method of claim 8, further comprising:
maintaining reception information of the second data packet, the reception information indicates at least one of:
a length of the second data packet;
a location of the partial payload stored in the memory;
a memory offset for locating the second data packet in the memory; or cyclic redundancy check of the second data packet.

11. The method of claim 8, wherein the second data packet comprises a USB3 packet, and the plurality of first data packets comprise a plurality of USB4 packets respectively comprising payloads for tunneling the USB3 packet without using a store and forward technique.

12. The method of claim 11, further comprising:
forwarding a partial payload of the USB3 packet before receiving all of the plurality of USB4 packets.

13. The method of claim 8, further comprising:
aligning a size of the partial payload of the second data packet with a bus width of the memory.

14. The method of claim 8, further comprising:
receiving a plurality of third data packets in sequence from the USB link, the plurality of third data packets being in compliance with the first communication protocol and configured to tunnel a fourth data packet in compliance with the second communication protocol; and
processing the plurality of third data packets and the plurality of first data packets based on respective priorities of the plurality of third data packets and the plurality of first data packets.

15. An apparatus for data communication, comprising:
a memory; and
a universal serial bus (USB) component coupled to the memory,
wherein the USB component is configured to:
fetch data from the memory to construct a first data packet in compliance with a first communication protocol;
form one or more second data packets in compliance with a second communication protocol that is different from the first communication protocol, each of the one or more second data packets comprising a payload for tunneling a portion of the first data packet; and
send the one or more second data packets using a USB link, prior to completing the construction of the first data packet.

16. The apparatus of claim 15, wherein the first communication protocol comprises a USB3 compliance protocol, and the second communication protocol comprises a USB4 compliance protocol.

17. The apparatus of claim 15, wherein the USB component is further configured to:
fetch an initial portion of the first data packet from the memory; and
form the one or more second data packets using the initial portion of the first data packet.

18. The apparatus of claim 17, wherein the USB component is further configured to:
align a size of the initial portion of the first data packet fetched from the memory with a bus width of the memory.

19. The apparatus of claim 15, wherein the first data packet comprises a USB3 packet, and the one or more second data packets comprise one or more USB4packets respectively comprising payloads for tunneling the USB3 packet without using a store and forward technique.

20. The apparatus of claim 19, wherein the USB component is further configured to:
send at least one of the one or more USB4 packets prior to completing the construction of the USB3 packet.
